(19) United States
(12) Patent Application Publication
(10) Pub. No.: US 2007/0217112 A1
(43) Pub. Date: Sep. 20, 2007

(54) OVERVOLTAGE PROTECTION DEVICE WITH A SIMPLIFIED DESIGN AND INCREASED RELIABILITY

(76) Inventor: ALAIN RENE ROBERT LAGNOUX, Rabastens de Bigorre (FR)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/678,458

(22) Filed: Feb. 23, 2007

(30) Foreign Application Priority Data
Feb. 24, 2006 (FR) 06 01679

(51) Int. Cl. H02H 9/06

(52) U.S. Cl. 361/118

(57) ABSTRACT

A device (1) for protecting an electrical installation from overvoltages, including a casing (2) that defines an interior recess (3), a varistor (4) placed in the recess (3), and having a first and a second pole (9, 10) and first and second opposite surfaces (5, 6) from which the first and second poles (9, 10) respectively emerge, and means (17) for holding the varistor (4) in position in the recess (3), wherein the holding means (17) extend between a first end (17A) toward which the holding means (17) are attached to the casing (2) and a second end (17B) toward which the holding means (17) are attached to the first surface (5), the holding means (17) extending, between the ends (17A, 17B), substantially outside of the space (18) located opposite each of the first and second surfaces (5, 6).

### FIELD OF THE INVENTION

This invention relates to protection of electrical equipment or installations, such as electrical apparatuses, circuits or distribution networks, from electrical power supply disturbances.

This invention relates more specifically to the technical field of devices for protection against voltage disturbances, such as overvoltages, in particular, transient overvoltages, especially those caused by lightning.

This invention also relates to a method for producing a device for protecting an electrical installation from overvoltages.

This invention further relates to a method for producing a varistor.

### BACKGROUND OF THE INVENTION

Devices for protecting electrical equipment from overvoltages, in particular, transient overvoltages, especially due to lightning, are well known.

Such devices, which are sometimes designed under the name surge suppressor or lightning arrestor, are intended to conduct default currents to the ground (in particular, lightning currents), and to limit the overvoltages induced to levels compatible with the capacity of the equipment and materials connected downstream of the protection devices. To this end, these protection devices are generally connected between the phase(s) powering the equipment to be protected and the ground.

In particular, protection devices that implement, as the overvoltage protection component, at least one varistor, i.e., an electrical component of which the resistance (or impedance) value varies significantly according to the voltage applied at its poles, is known. More specifically, varistors have a very high resistance (or impedance) while the voltage at their poles does not reach a threshold value; beyond this threshold, the impedance falls significantly. Metal oxide varistors (MOV) are preferably used. Thus, in normal operation (i.e., in the absence of a default current, such as an overvoltage current), the varistor has a high enough impedance not to cause a short circuit between the phase powering the installation to be protected and the ground. When an overvoltage occurs, for example, due to a default current, such as a lightning current, the resistance (or impedance) of the varistor fails to allow the default current to be conducted to the ground. When the overvoltage episode is over, the varistor automatically returns to its high initial impedance.

Thus, in normal operation, i.e., at normal voltage levels, the impedance of the varistor is high enough for the current traversing to be conducted to the ground, called a leakage current, to be negligible (for example, with an intensity under a milliampere).

However, the aging of the current-carrying varistor, which can also be accelerated by lightning shocks, causes a gradual decrease in this impedance and, therefore, an increase in the intensity of the leakage current. This increase in the leakage current causes significant heating of the varistor by the Joule effect, which heating contributes to the decrease in the impedance and, therefore, to the increase in the intensity of the leakage current. This phenomenon, called thermal runaway, results in a considerable increase in the temperature of the surface of the varistor, which can, for example, be greater than 150° C. The heat released by the varistor at the end of its lifetime is capable of being transmitted to surrounding equipment and materials, which can lead to serious risks of fire and/or short-circuiting.

This is why the international standards regulating the design of overvoltage protection devices of the lightning arrestor type, stipulate that the varistors mounted in these devices be equipped with thermal disconnection means disconnecting the device for protecting the equipment to be protected when the temperature of the varistor exceeds a predetermined critical threshold. This disconnection is more generally accompanied by a visual signal, obtained by display means, indicating to the user that the protection device needs to be replaced. In some known protection devices, the thermal disconnection is achieved, for example, by melting a solder, which releases an elastic leaf, the extension of which opens the electrical circuit into which the varistor of the protection device is inserted.

The known varistors generally used in the production of lightning arrestors are usually in the form of a substantially parallelepiped component with first and second opposing surfaces, mutually spaced by a distance corresponding to the thickness of the varistor, and separated by a lateral wall extending from the periphery of the surfaces, between the surfaces.

First and second metal pins emerge respectively from the first and second surfaces. The pins correspond respectively to the first and second poles of the varistor. These pins are intended to be electrically connected to the installation to be protected from overvoltages.

The known devices generally include a casing defining an interior recess in which the varistors are placed. The casing includes, in particular a frontal face arranged substantially opposite and at a distance from the first surface of the varistor, and a rear face, against which the varistor is placed, the second surface coming into contact with the rear face to hold the varistor in position in the casing. The second pin that emerges from the second surface is directly connected to a second connection terminal intended to provide the electrical connection of the device for protecting the installation to be protected. The first pin, which emerges from the first surfaces, is series mounted with the thermal disconnection means (and possibly the display means associated therewith), which is connected to a first connection terminal.

Such devices, while generally satisfactory, still have a number of disadvantages.

First, the fact that the second surface of the varistor is placed against the rear face of the casing creates a direct thermal bridge between the varistor and the casing. Thus, in the case of runaway of the varistor, the heat released by the varistor, before the varistor is disconnected by the thermal disconnection means, is transmitted directly to the casing, which increases the risk of damage or even fire.

In addition, the varistor used in a lightning arrestor is specifically sized, with regard to the electrical properties of the varistor, according to the characteristics of the installation to be protected and the overvoltage phenomena capable of occurring. More specifically, the thickness of the varistor is generally associated with the voltage properties of the varistor, while the area of the surfaces of the varistor is associated with the amount of energy that the varistor can dissipate. In practice, varistors of different thicknesses are implemented according to the protection constraints. This means, for known devices, providing a specific casing for a given varistor thickness. Indeed, according to the thickness of the varistor, the approach of the thermal disconnection means and the first pin occurs at more or less of a distance from the rear face against which the second surface of the varistor is pressed. To enable this approach between the thermal disconnection means and the first pin corresponding to the first pole, it is necessary to adapt the casing for each varistor thickness, or to adapt at least the length and/or the shape of the first pin, or even the thermal disconnection means (and possibly the display means).

The known devices have the drawback of a lack of standardisation, which complicates the management of production, requires additional qualified labour and increases production costs.

### SUMMARY OF THE DISCLOSURE

The features of the present invention address the various disadvantages mentioned above and provide a new device for protecting an electrical installation from overvoltages, which has an improved level of safety as well as a particularly simple and inexpensive construction.

A feature of the present invention is to provide a device for protecting an electrical installation from overvoltages constructed from a small variety of standardised components.

Another feature of the present invention is to provide a device for protecting an electrical installation from overvoltages produced using a minimum number of components.

Another feature of the present invention is to provide a particularly heavy-duty device for protecting an electrical installation from overvoltages.

Another feature of the present invention is to provide a device for protecting an electrical installation from overvoltages which minimizes the risks of fire in the event of thermal runaway of the varistor.

Another feature of the present invention is to provide a varistor that makes it possible to produce a device for protecting an electrical installation from overvoltages having an improved level of safety as well as low production costs.

Another feature of the present invention is to provide a varistor with a particularly simple construction similar to that of the varistors of the prior art.

Another feature of the present invention is to provide a method for producing a device for protecting an electrical installation from overvoltages, which is particularly simple and can be implemented quickly.

Another feature of the present invention is to provide a method for producing a device for protecting an electrical installation from overvoltages, which requires the implementation of only a small number of very simple operations and which does not require any particular skills or training.

Another feature of the present invention is to provide a method for producing a varistor that is particularly simple, fast and inexpensive to implement.

The features of the present invention are achieved by a device for protecting an electrical installation from overvoltages, including a casing that defines an interior recess; a varistor placed in the recess, and having a first and a second pole, and first and second opposite surfaces from which the first and second poles respectively emerge; and means for holding the varistor in position in the recess; wherein the holding means extend between a first end toward which the holding means are attached to the casing and a second end toward which the holding means are attached to the first surface, the holding means extending, between the ends, substantially outside of the space located opposite each of the first and second surfaces.

The features of the present invention are also achieved by a varistor including a first and a second pole, the first pole including a first connection pin intended to be connected to disconnection means; first and second opposite surfaces from which the first and second poles respectively emerge; and a lateral wall extending between the first and the second surface, the lateral wall contained in a dummy cylinder, the generator of which is the lateral wall; the varistor further comprising at least one support pin attached to the first surface and projecting from the dummy cylinder to the outside of the dummy cylinder.

The features of the present invention are also achieved by a method for producing a device for protecting an electrical installation from overvoltages, including a step of producing or providing a casing defining an interior recess; a step of producing or providing a varistor having a first and a second pole, and first and second opposite surfaces from which the first and second poles respectively emerge, the varistor intended to be placed in the recess; and a step of holding the varistor in position in the recess; wherein the step of holding the varistor in position inside the recess is performed by holding means extending between at least a first end toward which the holding means are attached to the casing and a second end toward which the holding means are attached to the first surface, the holding means extending, between the ends, substantially outside of the space located opposite each of the first and second surfaces.

The features of the present invention are also achieved by a method for producing a varistor, the varistor including a first and a second pole, the first pole including a first connection pin intended to be connected to disconnection means; first and second opposite surfaces from which the first and second poles respectively emerge; and a lateral wall extending between the first and the second surface, the lateral wall contained in a dummy cylinder, the generator of which is the lateral wall; the varistor further comprising a step in which at least one support pin is attached to the first surface, the support pin projecting from the dummy cylinder toward the outside of the dummy cylinder.

### BRIEF DESCRIPTION OF THE DRAWINGS

Other special features and advantages of the present invention will appear in greater detail on reading the following description, and with reference to the drawings provided purely for illustrative and non-limiting purposes.

FIG. 1 is a front view of the inside of the casing of a protection device according to a first exemplary embodiment of the present invention;

FIG. 2 is a cross-section view along the line A-A of the device of FIG. 1 with the casing closed;

FIG. 3 is the cross-section view along the line A-A of a varistor according to a first exemplary embodiment, implemented in the device shown in FIGS. 1 and 2;

FIG. 4 is a cross-section view of a varistor according to a second exemplary embodiment of the present invention; and

FIG. 5 is a diagrammatic perspective view of a varistor according to a third exemplary embodiment of the present invention.

### DETAILED DESCRIPTION OF THE EMBODIMENTS

The invention relates to a device 1 for protecting an electrical installation (not shown) from overvoltages. For purposes of the present disclosure, the term “electrical installation” refers to any type of installation, apparatus, instrument, network or electrical or telecommunication circuit capable of being subject to electrical power supply risks and, in particular, overvoltages, especially transient overvoltages, such as those due to lightning. In the case of lightning, the protection device 1 advantageously constitutes a lightning arrestor. As is well known in the field, the overvoltage protection device 1 according to the present invention is shunt-connected to the installation to be protected. The overvoltage protection device 1 according to the present invention is electrically connected between a phase of the installation to be protected and the ground.

However, it is possible to consider, without going beyond the scope of the present invention, that the device 1, instead of being shunt-connected between a phase and the ground, is connected between a neutral conductor and the ground, between the phase and the neutral conductor or between two phases (in the case of differential protection).

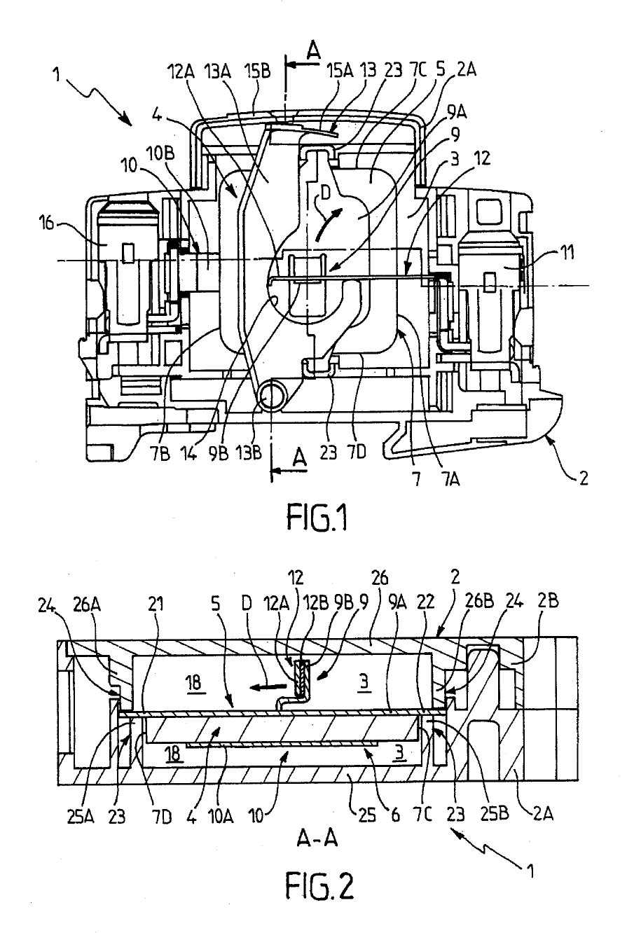

As shown in FIGS. 1 and 2, the protection device according to the present invention includes a casing 2, made, for example, as is known per se, of an insulating material such as a plastic material. The casing 2 defines an interior recess 3. In other words, the casing 2 is hollow, and defines an empty internal volume corresponding to the recess 3. As will be described in greater detail below, the recess 3 is intended to receive, in particular, an overvoltage protection component, which component is intended to be shunt-connected to the electrical installation to be protected. According to the present invention, the protection device 1 includes, as the protection component, a varistor 4 placed in the recess 3, i.e., inside the casing 2.

The device 1 can include more than one varistor or can include only one varistor formed by the functional assembly of a plurality of varistors without going beyond the scope of the present invention.

A varistor is a component of which the resistance (or impedance) is variable according to the voltage applied to it. Such components are well known in the art. The varistor 4 is preferably a metal oxide varistor (also referred to as “MOV”).

According to the present invention, and as is well known as in the art, the varistor 4 has a first surface 5 and a second surface 6, opposite one another. The first and second surfaces 5, 6 are spaced apart from one another by a distance corresponding to the thickness of the varistor 4. The varistor 4 preferably also includes a lateral wall 7 extending between the first surface 5 and the second surface 6, according to the thickness, the lateral wall 7 connecting the surfaces 5, 6 to their periphery. The lateral wall 7 preferably has a substantially annular shape of which the contour corresponds to that of the periphery of the surfaces 5, 6. In other words, the lateral wall 7 is contained in a dummy cylinder 8 of which the generator is the lateral wall, i.e., the dummy cylinder 8 “presses” on the lateral wall 7. As shown in the figures, the first and second surfaces 5, 6 are advantageously substantially planar and extend substantially parallel to one another, at a distance from one another, while the lateral wall 7 extends substantially perpendicular to the first and second surfaces 5, 6. As shown in the figures, the first and second surfaces 5, 6 are preferably substantially identical, at least with regard to their general shape and size.

As shown in FIGS. 1-4, the first surface 5 and the second surface 6 advantageously each have a substantially rectangular shape, and preferably a square shape. The angles of each surface 5, 6 can be substantially rounded, as shown in FIG. 1. In this case, the varistor 4 advantageously has a substantially parallelepiped shape, with the lateral wall 7 being formed by four substantially planar panels 7A, 7B, 7C, 7D, parallel two-by-two. In this exemplary embodiment, the dummy cylinder 8 is a cylinder with a square base, the sides of the square corresponding to the panels 7A, 7B, 7C, 7D.

However, it is entirely possible to envisage the varistor 4 having any other shape well known to a person skilled in the art, and, for example, as shown in FIG. 5, a disk shape, in which the first and second surfaces 5, 6 have a rounded, circular shape, while the lateral wall 7 has a circular ring shape. In this exemplary embodiment, the dummy cylinder 8 is a cylinder with a circular base.

The varistor 4 also has a first pole 9 and a second pole 10, intended to be electrically connected to the electrical installation to be protected, as is well known per se. The first pole 9 extends from the first surface 5, while the second pole 10 extends from the second surface 6 of the varistor. In other words, the first and second poles 9, 10 emerge respectively from the first and second surfaces 5, 6. Such a configuration is also well known per se.

The first pole 9 preferably includes at least one first connection plate 9A extending against the first surface 5, substantially parallel to the first surface 5. The first connection plate 9A is preferably made of a metal material.

The first pole 9 also advantageously includes a first connection pin 9B electrically connected to the first connection plate 9A, and to a first connection terminal 11 mounted in the casing 2. The first connection pin 9B preferably extends from the first connection plate 9A, and even more preferably forms a single piece with the plate 9A.

The connection terminal 11 is designed to be electrically connected to an electrical cable (not shown) connecting the connection terminal 11 to the electrical installation to be protected (not shown).

The device 1 according to the present invention advantageously includes means 12 for electrical disconnection of the varistor 4, the disconnection means 12 is electrically connected to the first pole 9. The electrical disconnection means 12 are sensitive to the temperature of the varistor 4, and are designed to disconnect the varistor 4 from the electrical installation to be protected when the temperature of the varistor 4 reaches a predetermined value reflecting a malfunction of the varistor 4. The disconnection means 12 form means for thermal disconnection of the varistor 4.

In the example shown in FIGS. 1 and 2, the disconnection means 12 include a disconnection leaf 12A electrically connecting the first connection terminal 11 and the first connection pin 9B, i.e., the varistor 4 includes a first connection pin 9B connected to the electrical disconnection means 12, which is also connected to the first connection terminal 11 in order to ensure electrical continuity between the pin 9B and the terminal 11. The leaf 12A, which is electrically conductive, is series mounted between the first connection pin 9B and the first connection terminal 11. The leaf 12A is attached to the first connection pin 9B by a fuse element 12B, formed, for example, by welding. The leaf thus welded to the first pin 9B and to the first terminal 11 ensures the passage of the current between the first terminal 11 and the first pole 9. Preferably, and for the sake of compactness and to minimise the size of the recess 3, the first connection pin 9B extends substantially opposite the first surface 5, so that the point of connection between the pin 9B and the leaf 12A produced by the fuse element 12B is positioned opposite the first surface 5.

Under the effect of abnormal heating of the varistor 4, the fuse element 12B is designed to melt and release the leaf 12A. The leaf 12A, due to its elastic nature, will extend, in direction D, to arrive at a stable return position in which the leaf 12A is far enough from the first connection pin 9B to break the electrical contact between the leaf 12A and the first connection pin 9B. In this configuration, the electrical contact between the first terminal 11 and the first pin 9B is broken.

Of course, it is entirely possible to envisage, without going beyond the scope of the present invention, the disconnection means 12 including technical means other than an elastic leaf and a fuse element. In this context of the present invention, any other thermal disconnection means known to a person skilled in the art can be implemented.

The disconnection means 12 are functionally connected to display means 13 making it possible for the user, without disassembling the casing 2, to determine whether the varistor 4 is still connected to the installation to be protected or if the varistor 4 has instead been disconnected from the installation due to a deflection of the leaf 12A as a result of the melting of the fuse element 12B. For example, as shown in FIG. 1, the display means 13 can include a cam mounted for free rotation on the casing 2 by means of a rotation shaft 13B. The cam 13A is advantageously provided with a rounded notch 14 cooperating with the leaf 12A so that when the leaf 12A extends toward the open and return position, the leaf 12A pushes the cam 13A, which causes the rotation of the cam 13A. The cam 13A is provided with a signalling area 15A, for example, red-coloured, which appears opposite a window 15B provided in the casing 2, when the cam 13A pivots under the action of the deflection of the leaf 12A.

Of course, the present invention is not limited to the implementation of a specific display system, as any display system known to a person skilled in the art can be implemented without going beyond the scope of the present invention.

As shown in the figures, the disconnection means 12, and the display means 13, are preferably contained in the casing 2.

The second pole 10 also includes at least one second connection plate 10A extending against the second surface 6, substantially parallel to the second surface 6. The second pole 10 also includes a second connection pin 10B electrically connected to the second plate 10A and to a second connection terminal 16 mounted in the casing 2. The second connection pin 10B preferably extends from the plate 10A, and even more preferably forms a single piece with the first connection plate 10A. The second pole 10 is directly connected to the second connection terminal 16, the function of which is similar to that of the first connection terminal 11 described above.

According to the present invention, the protection device 1 includes means for holding the varistor 4 in position 17 in the recess. The function of the position-holding means 17 is to help, at least to a certain extent, hold the varistor 4 in a stationary and immobile position in the recess 3 provided in the casing 2. The holding means 17 are separate from the connection pins 9B, 10B used to electrically connect the varistor 4 to the terminals 11, 16 and perform the function of holding the varistor 4 in position regardless of the state of the disconnection means 12.

The holding means 17 extend between a first end 17A, toward which the holding means 17 are connected, and more specifically attached to the casing 2, and a second end 17B, toward which the holding means 17 are attached to the varistor 4, and more specifically attached to the first surface 5 of the varistor 4.

In other words, the holding means 17 provide a mechanical connection that is preferably a fitting connection, between the varistor 4 and the casing 2, to attach and immobilise the varistor 4 in the casing 2. The holding means 17 are attached to the varistor 4 toward the second end 17B. The mechanical connection between the holding means 17 and the varistor 4 is a fitting connection. The holding means 17 cooperate, toward the first end 17A, with the casing 2, to lock the varistor 4 in position. The connection between the holding means 17 and the casing 2 is also preferably a fitting connection, preferably by cold fusion (without welding), obtained by mechanical assembly.

As indicated above, the holding means 17 primarily or essentially help to hold the varistor 4 in position in the casing 2. It is possible to consider other elements outside of the holding means 17 and separate from the holding means 17, also helping, to a lesser degree, to hold the varistor 4 in position in the recess 3, without going beyond the scope of the present invention.

According to an important feature of the present invention, the holding means 17 extend, between the first end 17A and the second end 17B, substantially outside of the space 18 located opposite each of the first and second surfaces 5, 6. In other words, the holding means 17 extend laterally, relative to the varistor 4, i.e., the active portion, which connects the varistor 4 to the casing 2, extends outside of the space 18 located opposite the first and second surfaces 5, 6, i.e., opposite the surfaces 5, 6 on the normal thereof.

Thus, in the context of the exemplary alternatives shown in the figures, the holding means 17 advantageously project from the dummy cylinder 8 to the outside of the dummy cylinder 8.

Owing to this technical feature, it is no longer necessary to use one, the other or both of the first and second surfaces 5, 6 as holding means, i.e., it is no longer necessary to place one, the other or both surfaces 5, 6 against the casing 2.

This makes it possible, in particular, to provide a free space 18 opposite the surfaces 5, 6, which free space allows for better thermal insulation of the casing 2 relative to the varistor 4, and a better level of safety if the varistor 4 heats up. The presence of a free space 18 opposite each of the opposite surfaces 5, 6 makes it possible either to create an insulating air space on each side of the varistor 4 or to fill this free space with an insulating substance, such as a resin or a foam.

The present invention makes it possible to suspend the varistor 4 in the casing 2, inside the recess 3, using the holding means 17. The present invention can also be defined, in a specific exemplary embodiment, as including a casing 2 equipped with means for receiving the holding means 17, designed so that the varistor 4 is suspended in the recess 3 by the holding means 17.

The present invention also relates, as such, and independently, to an overvoltage protection device 1 including a casing 2 defining an interior recess 3, and a varistor 4 mounted at a distance from the walls of the casing 2, to provide a free space substantially around the entire varistor 4. It is entirely possible to consider, in the context of this exemplary alternative, that one or the other of the surfaces 5, 6 of the varistor 4, are flush with the casing 2, or even come into contact with the casing 2, insofar as holding means 17 are implemented, which extend substantially outside of the space 18 located opposite each of the first and second surfaces 5, 6.

The holding means 17 advantageously extend, at least in part, substantially perpendicular to the lateral wall 7. In the case of the exemplary embodiment shown in FIGS. 1-3 and 5, the holding means 17 extend entirely perpendicular to the lateral wall 7, and, therefore, to the dummy surface of the dummy cylinder 8 in which the lateral wall 7 is contained.

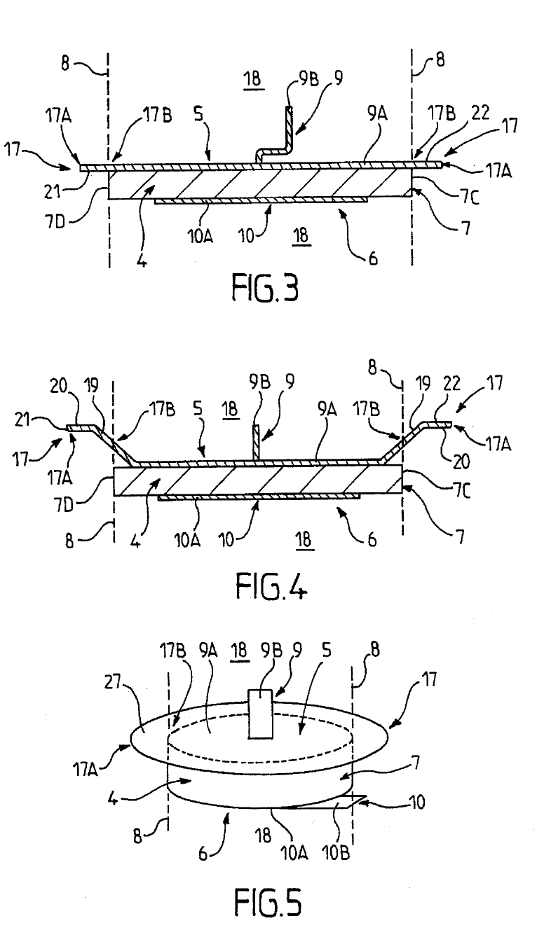

In the case of the exemplary embodiment shown in FIG. 3, the holding means 17 include a first segment 19 that extends substantially obliquely with respect to the lateral wall 7, wherein the first segment 19 is extended by a second segment 20 substantially perpendicular to the lateral wall 7.

The holding means 17 advantageously extend, at least in part, substantially in a tangential plane with respect to the first surface 5 from which the first pin 9B emerges, which pin is intended to be connected to the disconnection means 12, as shown in FIGS. 2, 3 and 5.

The holding means 17 are preferably securely connected to the first pole 9, which is intended to be series connected to the disconnection means. Even more preferably, the holding means 17 form a single piece with the first pole 9. The holding means 17 advantageously include at least one support pin, and preferably two support pins 21, 22 extending from the first plate 9A and preferably forming a single piece with the first plate 9A. Thus, the first plate 9A and the holding means 17 form a single piece, with the holding means 17 forming an extension of the plate 9A outside of the space 18 located opposite the first surface 5, from which the first connection pin 9B emerges, which pin is intended to be connected to the disconnection means 12. Each support pin 21, 22 preferably extends substantially in the same plane as the first plate 9A, i.e., parallel to the first surface 5.

In other words, each support pin 21, 22 preferably extends substantially tangentially to the first surface 5 and perpendicular to the direction of the thickness of the varistor 4. As shown in FIGS. 1-4, the device 1, and more specifically the varistor 4, advantageously include two support pins 21, 22 attached to the first surface 5, each projecting from the dummy cylinder 8 to the outside thereof, in opposite respective directions. Other construction details can be envisaged. For example, in the exemplary alternative shown in FIG. 5, the holding means 17 include a substantially circular flange 27 that extends from the plate 9A, outside of the interior volume defined by the dummy cylinder 8.

The present invention thus relates independently to a varistor 4 including a first and a second pole 9, 10, the first pole 9 including a first connection pin 9B intended to be connected to disconnection means 12; first and second opposite surfaces 5, 6 from which the first and second poles 9, 10 respectively emerge; and a lateral wall 7 extending between the first and the second surface 5, 6, the lateral wall 7 being contained in a dummy cylinder 8, the generator of which is the lateral wall 7 itself; the varistor 4 including at least one support pin 21, 22 attached to the first surface 5 and projecting from the dummy cylinder 8 to the outside thereof. The support pin 21, 22 is separate from the first connection pin 9B.

The first connection pin 9B preferably extends substantially perpendicular to the first surface 5, while the support pin 21, 22 extends substantially tangentially to the first surface 5. The connection pins 9B and support pins 21 advantageously form a single piece with the pole 9.

The present invention is not limited to a specific shape or orientation of the connection pins 9B, 10B and support pins 21, 22. However, the configuration shown in FIGS. 1-3 is preferred, in which the support pins 21, 22 extend in opposite directions, substantially parallel to the first surface 5, while the first connection pin 9B extends substantially perpendicular to the first surface 5, at the center thereof, with the second connection pin extending substantially parallel to the second surface 6 and the support pins 21, 22.

The casing 2 advantageously includes a support 23 against which the holding means 17 press toward the first end 17A. In other words, in the case of the exemplary alternatives shown in FIGS. 1-4, the support pins 21, 22 attached to the first surface 5 of the varistor 4, rest in a stable manner against the support 23.

The casing 2 advantageously also includes blocking means 24 pressing against the holding means 17, so that the holding means 17 are interposed between the support 23 and the blocking means 24, which contributes to, or entirely ensures, the immobilisation of the holding means 17, and, therefore, of the varistor 4 to which the holding means 17 is attached. In other words, the support 23 and the blocking means 24 form the two parts of a jaw enclosing and blocking the holding means 17 toward (i.e., in the vicinity of) the first end 17A, wherein the holding means 17 are securely connected to the varistor 4 toward the second end 17B.

As shown in FIG. 2, the casing preferably includes a lower half-casing 2A and an upper half-casing 2B, which are complementary, the lower half-casing 2A and upper half-casing 2B are assembled, for example, by a click-lock connection, to define together, once assembled, a closed internal volume forming the recess 3.

The support 23 is advantageously borne by, and preferably forms a single part with, the lower half-casing 2A, while the blocking means 24 are borne by, and preferably form a single part with, the upper half-casing 2B. The lower half-casing 2A advantageously includes a lower face 25, arranged opposite the second surface 6, and forming a wall insulating the inside of the casing 2 from the outside. The lower face 25 contains at least one lower rib forming the support 23. In the case of the exemplary alternative shown in FIG. 2, two lower ribs 25A, 25B rise from the lower face 25 to act as respective supports for the first and second support pins 21, 22, which come into contact with the lower ribs 25A, 25B. The height of the lower ribs 25A, 25B is preferably chosen so that the second surface 6 of the varistor 4 does not come into contact with the lower face 25, but is instead held at a distance from the lower face 25.

The upper half-casing 2B advantageously includes an upper face 26 arranged opposite the first surface 5, and forming a wall insulating the inside of the casing 2 from the outside. The lower and upper faces 25, 26 are preferably substantially planar and parallel. From the upper face 26, at least one upper rib 26 extends, forming the blocking means 24. In the case of the exemplary alternative shown in FIG. 2, two upper ribs 26A, 26B rise from the upper face 26 to cooperate respectively with the first and second support pins 21, 22. The support pins 21, 22 are held in a vice-like grip between the lower ribs 25A, 25B and the upper ribs 26A, 26B. The height of the upper ribs 26A, 26B emerging from the upper face 26 is preferably adequate for providing a free space opposite the first surface 5, with the free space being of a sufficient height to contain the first connection pin 9B as well as the disconnection means 12 and the display means 13 that may be associated therewith.

Thus, the casing 2 includes an upper face 26 arranged opposite the first surface 5 and a lower face 25 arranged opposite the second surface 6, with the holding means 17 holding the varistor 4 at a distance from the lower 25 and upper 26 faces to provide a substantially free space opposite the first and second surfaces 5, 6.

It is entirely possible to consider, without going beyond the scope of the present invention, that a partition (not shown), parallel to the upper 26 and lower 25 faces is also arranged against and along the first surface 5, with an aperture being provided in the partition to allow the first connection pin 9B to pass through.

In the particularly advantageous exemplary embodiment shown in the figures, the present invention makes it possible, by attaching the holding means 17 to the first surface 5 from which the first connection pin 9B emerges, which pin is intended to interact with the disconnection means 12, to guarantee that the first connection pin 9B is always strictly in the same place in the casing 2, regardless of the thickness of the varistor 4, insofar as the height of the support 23 with respect to the lower face 25 has been properly chosen. Indeed, as can be seen in FIG. 2, even if the protection conditions require the use, in the casing 2 shown in FIG. 2, of a varistor having a thickness greater than that of the varistor shown in FIG. 2, the first connection pin 9B will not be raised, which would consequently modify the attachment of the first connection pin 9B with the connection means 12. This advantage is obtained very simply, without requiring the addition, for example, of specific elements in the casing 2, such as an intermediate bearing partition for the first surface 5.

The present invention also relates to a method for producing a device 1 for protecting an electrical installation from overvoltages.

One exemplary embodiment provides a method which includes a step of producing, or providing, a casing 2 defining an interior recess 3. The method according to the present invention also includes a step of providing or producing a varistor 4 having a first pole 9 and a second pole 10, and first and second opposite surfaces 5, 6 from which the first and second poles 9, 10 respectively emerge, the varistor 4 being intended to be placed in the recess 3. The method according to the present invention also includes a step of holding the varistor 4 in position in the recess 3, i.e., a step in which the varistor 4 is positioned in the recess 3, relative to the casing 2.

The step of holding the varistor 4 in position in the recess 3 is performed, according to the present invention, by way of holding means 17 extending, as described above, between at least one end 17A toward which the holding means are attached to the casing 2 and a second end 17B toward which the holding means 17 are attached to the varistor 4. In other words, during the holding step, a mechanical connection is established with the assistance of a mechanical assembly part formed by the holding means 17, between the varistor 4, positioned in the recess 3, and the casing 2. This mechanical connection, in particular, involves the attachment, i.e., the secure connection, of the holding means 17 to the varistor 4, as well as the cooperation of the holding means 17 with the casing 2 to keep the varistor 4 immobile in the recess 3.

The cooperation between the holding means 17 and the casing 2 can be a simple bearing cooperation or a fitting cooperation, for example.

According to an important feature of the present invention, the holding step is performed so that the holding means 17 extend, between the first and second ends 17A, 17B, substantially outside of the space 18 located opposite each of the first and second surfaces 5, 6 of the varistor 4. In other words, the holding step is advantageously a step of lateral attachment of the varistor 4 in the casing 2, and more preferably a step of suspension of the varistor 4 in the casing 2, in the recess. By implementing such a suspension step, the varistor 4 is not deposited in the casing 2, i.e., the varistor 4 is not held in position, unlike in the prior art, by the direct pressure of one of the surfaces 5, 6 on the casing 2 (or on a part attached to the casing 2).

The step of producing (or providing) the casing 2 advantageously includes a first sub-step in which a lower half-casing 2A is provided, which includes a support 23 against which the holding means 17 are intended to press toward the first end 17A. As described above, the lower half-casing 2A preferably includes a substantially planar lower face 25 from which at least one rib forming a support 23 rises. In the case of the exemplary alternative shown in FIG. 2, the support 23 includes two lower ribs 25A, 25B rising opposite one another, with the distance between the ribs 25A, 25B being adequate to allow the insertion, between the ribs 25A, 25B, of the varistor 4 so that the second surface 6 thereof is opposite the lower face 25.

The step of holding the varistor 4 in position advantageously includes a first sub-step in which the varistor 4 is arranged with respect to the lower half-casing 2A so that the holding means 17 press, at the first end 17A, against the support 23. In the case of the exemplary alternative shown in FIG. 2, this first sub-step is performed as follows. The lower half-casing 2A rests in a stable manner on a preferably planar working surface against the lower face 25. The varistor 4, from which the first and second support pins 21, 22 extend, is inserted between the ribs 25A, 25B, so that the first pin 21 is placed on the rib 25A, while the second pin 22 is placed on the corresponding rib 25B, with the second surface 6 facing the lower face 25. The lateral wall 7, and more specifically the panels 7C, 7D, are respectively opposite the lower ribs 25B, 25A. At the end of the first holding sub-step, the varistor 4 rests in a stable manner against the ribs 25A, 25B, with its second surface 6 preferably at a distance from and opposite the lower face 25.

The step of producing (or providing) the casing 2 advantageously also includes a second sub-step in which an upper half-casing 2B is produced (or provided), which includes blocking means 24 intended to press against the holding means 17. As mentioned above, the upper half-casing 2B preferably includes an upper face 26 from which at least one upper rib rises to form the blocking means 24. In the case of the exemplary alternative shown in FIG. 2, the blocking means 24 include at least two upper ribs 26A, 26B which extend parallel to one another, at an adequate height, to define between them a space capable of receiving the first connection pin 9B, the disconnection means 12 and the display means 13.

The position-holding step advantageously includes a second sub-step, preferably following the first sub-step of the holding step. During this second sub-step, the upper half-casing 2B is placed on and against the lower half-casing 2B so that the blocking means 24 press against the holding means 17, the holding means 17 are interposed, and stuck, between the support 23 and the blocking means 24. The method according to the present invention makes it possible to immobilise the varistor 4 in position inside the casing 2 in a particularly simple, fast and effective manner, simply by stacking a lower half-casing 2A, a varistor 4 to which lateral holding means 17 are attached, and an upper half-casing 2B.

The present invention also relates to a method for producing a varistor 4, wherein the varistor 4 includes a first and a second pole 9, 10, the first pole 9 including a first connection pin 9B intended to be connected to disconnection means 12; first and second opposite surfaces 5, 6 from which the first and second poles 9, 10 respectively emerge; and a lateral wall 7 extending between the first and the second surface 5, 6, the lateral wall 7 being contained in a dummy cylinder 8, the generator of which is the lateral wall 7.

The first connection pin 9B is specifically designed and intended to provide the interface between the varistor 4 and disconnection means 12, which are preferably thermal disconnection means.

The first connection pin 9B is specifically designed and shaped to be assembled, by means of a fuse element 12B, to a disconnection leaf 12A.

According to an important feature of the method for producing a varistor 4 according to the present invention, the method includes a step in which at least one support pin 21, 22 is attached to the first surface 5, i.e., the surface 5 from which the first connection pin 9B emerges, which pin is intended to be connected to the disconnection means 12. The support in 21, 22 projects, from the dummy cylinder 8, to the outside of the dummy cylinder 8. The support pin 21, 22 is specifically designed to enable the varistor 4 to be held in position in a casing, and, for example, to enable the varistor 4 to be suspended in the casing. Preferably, as described above and shown in the figures, two support pins 21, 22 are attached to the first surface 5, which pins extend in opposite directions, perpendicular to the lateral wall 7 and tangentially to the first surface 5.

1. A device for protecting an electrical installation from overvoltages, comprising:
(a) a casing defining an interior recess;
(b) a varistor placed in the recess and having a first and a second pole and first and second opposite surfaces from which the first and second poles respectively emerge; and
(c) means for holding the varistor in position in the recess;
wherein the holding means extend between a first end toward which the holding means are attached to the casing and a second end toward which the holding means are attached to the first surface, the holding means extending, between said ends, substantially outside of the space located opposite each of the first and second surfaces.

2. The device of claim 1, wherein the varistor further comprises a lateral wall extending between the first and second surfaces, the lateral wall contained in a dummy cylinder which the generator is the lateral wall, the holding means projects from the dummy cylinder toward the outside of the dummy cylinder.

3. The device of claim 2, wherein the holding means extend, at least in part, substantially perpendicular to the lateral wall.

4. The device of claim 1, wherein the holding means extend, at least in part, substantially in a tangential plane with respect to the first surface.

5. The device of claim 1, wherein the holding means are securely connected to the first pole.

6. The device of claim 5, wherein the holding means form a single piece with the first pole.

7. The device of claim 1, wherein the first pole further comprises at least one first connection plate extending against the first surface, substantially parallel to the first surface, the holding means includes at least one support pin extending from the first plate substantially in the same plane as the first plate.

8. The device of claim 1, wherein the casing further comprises a support against which the holding means press toward the first end of the holding means.

9. The device of claim 8, wherein the casing further comprises blocking means pressed against the holding means so that the holding means are interposed between the support and the blocking means.

10. The device of claim 9, wherein the casing further comprises a lower half-casing and an upper half-casing assembled to define the recess, with the support being borne by the lower half-casing while the blocking means are borne by the upper half-casing.

11. The device of claim 1, wherein the casing further comprises an upper face arranged opposite the first surface and a lower face arranged opposite the second surface, wherein the holding means hold the varistor at a distance from the lower and upper faces to provide a substantially free space opposite the first and second surfaces.

12. The device of claim 1, further comprising means for electrical disconnection of the varistor, connected to the first pole.

13. The device of claim 12, wherein the varistor further comprises a first connection pin connected to the electrical disconnection means, the first connection pin extends substantially opposite the first surface.

14. A lightning arrestor, comprising:
(a) a casing defining an interior recess;
(b) a varistor placed in the recess and having a first and a second pole and first and second opposite surfaces from which the first and second poles respectively emerge; and
(c) means for holding the varistor in position in the recess:
wherein the holding means extend between a first end toward which the holding means are attached to the casings and a second end toward which the holding means are attached to the first surface, the holding means extending, between said ends, substantially outside of the space) located opposite each of the first and second surfaces.

15. A varistor, comprising:
(a) a first and a second pole, the first pole having a first connection pin connected to disconnection means;
(b) first and second opposite surfaces from which the first and second poles respectively emerge;
(c) a lateral wall extending between the first and the second surface, the lateral wall contained in a dummy cylinder, the generator of which is the lateral wall; and
(d) at least one support pin attached to the first surface and projecting from the dummy cylinder toward the outside of the dummy cylinder.

16. The varistor of claim 15, wherein the first connection pin extends substantially perpendicular to the first surface, while the support pin extends substantially tangentially to the first surface.

17. The varistor of claim 15, further comprising two support pins attached to the first surface and projecting from the dummy cylinder toward the outside of the dummy cylinder in opposite respective directions.

18. A method for producing a device for protecting an electrical installation from overvoltages, comprising the steps of:
(a) providing a casing defining an interior recess;
(b) providing a varistor having a first and a second pole and first and second opposite surfaces from which the first and second poles respectively emerge, the varistor is placed in the recess; and
(c) holding the varistor in position in the recess, by way of holding means extending between at least a first end toward which the holding means are attached to the casing and a second end toward which the holding means are attached to the first surface, wherein the holding means extend, between the ends substantially outside of the space located opposite each of the first and second surfaces.

19. The method of claim 18, wherein the step of producing or providing the casing further comprises a first sub-step of providing a lower half-casing, which includes a support against which the holding means press toward the first end, wherein the position-holding step includes a second sub-step comprising arranging the varistor with respect to the lower half-casing so that the holding means press toward the first end against the support.

20. The method of claim 19, wherein the step of producing or providing the casing further comprises a second sub-step comprising providing an upper half-casing, which includes blocking means intended to press against the holding means, wherein the position-holding step includes a second sub-step comprising placing the upper half-casing on the lower half-casing so that the blocking means press against the holding means and the holding means are interposed between the support and the blocking means.

21. A method for producing a varistor, the varistor comprising:
(a) a first and a second pole, the first pole having a first connection pin connected to disconnection means;
(b) first and second opposite surfaces from which the first and second poles respectively emerge; and
(c) a lateral wall extending between the first and the second surfaced, the lateral wall being contained in a dummy cylinder, the generator of which is the lateral wall;
the method comprising attaching at least one support pin to the first surface, wherein the support pin projects from the dummy cylinder to the outside of the dummy cylinder.
